(19) United States
(12) Patent Application Publication
(10) Pub. No.: US 2015/0340822 A1
(43) Pub. Date: Nov. 26, 2015

(54) MODULAR PLUG AND MANUFACTURING METHOD THEREOF

(71) Applicant: Ping Yen, Shenzhen (CN)

(72) Inventor: Ping Yen, Shenzhen (CN)

(73) Assignee: MEILU ELECTRONICS (SHENZHEN) CO., LTD., Shenzhen, Guangdong (CN)

(21) Appl. No.: 14/376,437

(22) PCT Filed: May 21, 2014
(86) PCT No.: PCT/CN2014/077947

§ 371 Date: Aug. 4, 2014

(51) Int. Cl. H01R 24/64; H01R 13/627; B29C 45/14

(52) U.S. Cl. CPC H01R 24/64; B29C 45/14639; H01R 13/6272; H01R 2107/00

(57) ABSTRACT

The present application is directed to a modular plug, including a terminal containing a metal contact, an upper surface of a front end of the terminal is provided with a recess, an upper side of the terminal is connected with a clamping elastic sheet through injection moulding, a front end of the clamping elastic sheet is provided with a projection that matches the recess in shape and size, the projection is tightly inlaid within the recess, a top end of the clamping elastic sheet extends downwardly and overlays on a front surface of the terminal, a material of the clamping elastic sheet is nylon or POM, and a material of the terminal is polycarbonate resin. The present application also discloses a method of processing such modular plug. The clamping elastic sheet can be repetitiously pressed and bent without breaking easily and the elastic piece can securely connect onto the terminal.

### FIELD OF THE TECHNOLOGY

The present application is directed to a modular plug, particularly, to a modular plug possessing an unbreakable clamping elastic sheet that can be repetitiously pressed and bent, and its manufacturing method.

### BACKGROUND

Modular plug is a very universal network connection accessory, which is used in realizing the connection between the cable and the cable interface of the network apparatus. Modular plug under the existing technology (such as RJ45 connector) mainly is provided with a terminal containing a metal contact and a clamping elastic sheet located at the upper side of the front end of the terminal and extending behind. The connecting portion of the clamping elastic sheet connecting to the upper side of the front end of the terminal is a clamping projection protruding on both sides. After the front end of the modular plug is inserted into a cable interface, the sloped clamping projection on the clamping elastic sheet is squeezed within the cable interface under the elastic effect, so that the modular plug is stabilized. When the cable needs to be plucked out, the clamping elastic sheet can be pressed and the modular plug is released. Modular plugs under existing technology all are formed in a one-time process using hard plastic material. Such will cause the clamping elastic sheet to be very easily broken in the process of repeatedly plugging in and out of the cable. Once the clamping elastic sheet breaks, the modular plug cannot tightly fasten inside the cable interface and be stabilized, rendering unreliable connection of the network.

### SUMMARY

In order to solve the above problem, the purpose of the present application lies in providing a modular plug possessing an unbreakable clamping elastic sheet that can be repetitiously pressed and bent.

The present application is realized through the following technical measures. A modular plug includes a terminal containing a metal contact, an upper surface of a front end of the terminal is provided with a recess, an upper side of the terminal is connected with a clamping elastic sheet through injection moulding, a front end of the clamping elastic sheet is provided with a projection that matches the recess in shape and size, the projection is tightly inlaid within the recess, a top end of the clamping elastic sheet extends downwardly and overlays on a front surface of the terminal, a material of the clamping elastic sheet is nylon or POM, and a material of the terminal is polycarbonate resin.

As a preferred embodiment, the clamping elastic sheet includes a connecting head fixed at the front end of the terminal and an elastic sheet extended in slanted upward direction from an end of the connecting head, the elastic sheet is provided with a clamping projection protruding from both sides and proximate to the end of the connecting head.

As a preferred embodiment, the connecting head and the elastic sheet are formed from one single injection moulding.

As a preferred embodiment, the modular plug is a RJ45, RJ50, RJ61, RJ48, RJ25, RJ14, RJ12 or RJ11 connector.

As a preferred embodiment, the recess has an oval gear shape and teeth of the recess that proximate to two ends of a central part of the recess form expanded dovetailed shape.

The present application also disclosed a method of manufacturing the above modular plug, including the following steps:

(1) firstly, injection molding the terminal of the material of polycarbonate resin, and then injection molding the terminal of the material of polycarbonate resin having a irregularly shaped recess using a mould cavity of a first rear mould and a convex mould of a first front mould; and

(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

As a preferred embodiment, the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.

The present application is formed from the processing of different materials with twice injection moulding under high temperature. The material of the clamping elastic sheet is nylon or POM, allowing the clamping elastic sheet to be able to be repetitiously pressed and bent yet not be easily broken, so as to ensure the reliability of the network connection. It inventively provided a recess at the upper surface of the front end of the terminal, and at the front end of the clamping elastic sheet is provided with a projection. The projection is tightly inlaid within the recess. The cooperation of the shapes of the bezel portion which overlays the terminal and extends downwardly from the top end of the clamping elastic sheet and the recess allows the clamping elastic sheet to fix stably on the terminal.

### BRIEF DESCRIPTION OF THE DRAWINGS

FIG. 1 is a structural illustrative view of an embodiment of the present application;

FIG. 2 is a structural illustrative view of a terminal of an embodiment of the present application;

FIG. 3 is a structural illustrative view of shrapnel clamping elastic sheet of an embodiment of the present application;

FIG. 4 is an illustrative view of the working process of a mould of an embodiment of the present application.

### DETAILED DESCRIPTION

Below is a further detailed description of the present application combining embodiments with reference to the drawings.

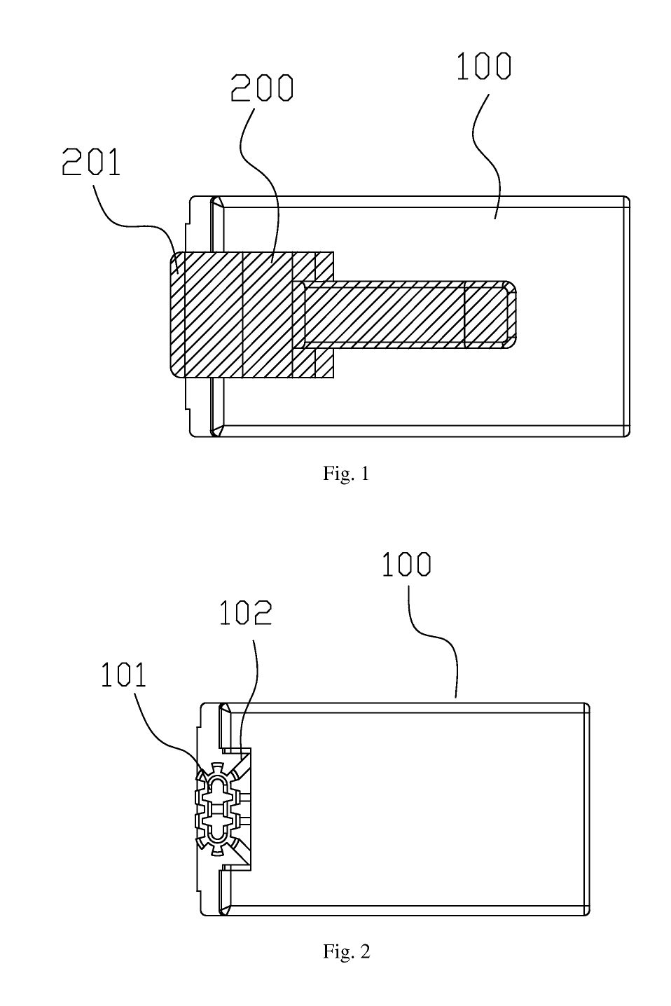

The modular plug of the present embodiment, referring to FIGS. 1-3, includes a terminal 100 containing a metal contact. The upper surface of the front end of the terminal 100 is provided with a recess 101. The upper side of the terminal 100 is connected with a clamping elastic sheet 200 through injection moulding. The front end of the clamping elastic sheet 200 is provided with a projection 202 that corresponds to the shape and size of the recess 101. The projection 202 is tightly inlaid within the recess 101. The top end of the clamping elastic sheet 200 extends downwardly and thus forms a bezel portion 201 that overlays the front side of the terminal 100. The material of the clamping elastic sheet 200 is nylon or POM. The material of the terminal 100 is polycarbonate resin.

The method of manufacturing the above modular plug, referring to FIG. 4, includes the following steps:

(1) Firstly, injection moulding a terminal 100 with the material of polycarbonate resin, and then injection moulding a terminal 100 of the material of polycarbonate resin having irregularly shaped recess using a mould cavity of a first rear mould 60 and a convex mould of the first front mould 40;

(2) Under the condition of guaranteeing the temperature of the injection moulding machine, opening and spirally loosening the first rear mould 60, covering the first rear mold 60 on the second front mould 30, injection moulding a clamping elastic sheet 200 with a material of nylon or POM using a mould cavity on the second front mould 30, opening and spirally loosening the first rear mould 60, and taking out the end product.

The present product is formed from the processing of different materials under twice injection moulding at high temperature. The material of the clamping elastic sheet 200 is nylon or POM, so that the clamping elastic sheet 200 can repetitiously be pressed and bent and cannot be broken easily. Therefore, the reliability of the network connection is ensured, and a recess 101 is inventively provided on the upper surface of the front end the terminal 100, and a projection 202 is inventively provided at the front end of the clamping elastic sheet 200. The projection 202 is tightly inlaid within the recess 101. The cooperation of the specific shapes of the bezel portion 201 which overlays the terminal 100 and extends downwardly from the top end of the clamping elastic sheet 200 and the recess 101 allows the clamping elastic sheet 200 to fix stably on the terminal 100.

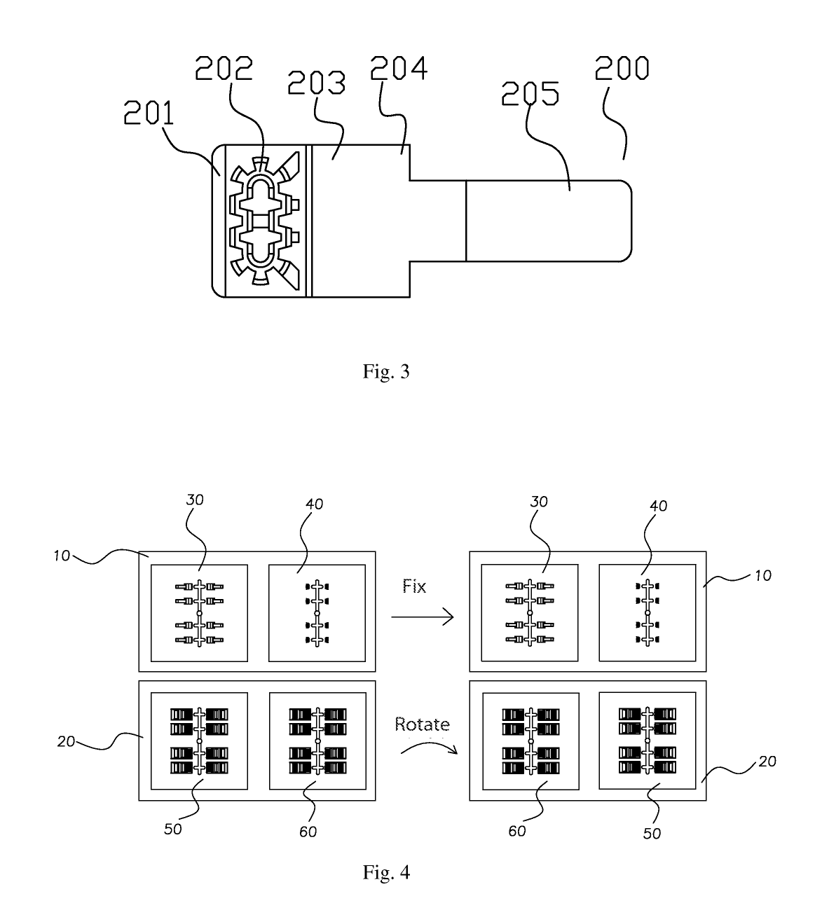

The modular plug of the present embodiment, referring to FIG. 3, and on the basis of the present technical solution, can be such that the clamping elastic sheet 200 includes a connecting head 203 fixed at the front side of the terminal and an elastic sheet 205 extending in slanted upward direction from the end of the connecting head 203. The elastic sheet 205 is provided with a clamping projection 204 protruding outward from both sides and proximate to the end of the connecting head 203.

The modular plug of the present embodiment, referring to FIG. 3, can specifically be, on the basis of the present technical solution, the connecting head 203 and the elastic sheet 205 are formed from one single injection moulding.

The modular plug of the present embodiment, referring to FIG. 1, can specifically be, on the basis of the present technical solution, modular plug is a connector including RJ45, RJ50, RJ61, RJ48 RJ25, RJ14, RJ12 or RJ11 etc.

The modular plug of the present embodiment, referring to FIG. 2, can specifically be, on the basis of the present technical solution, such that the recess 101 has an oval gear shape. The teeth proximate to the two ends of a central part of the recess 101 form expanded dovetailed shape 102. Through the cooperation between the bezel portion 201 which overlays the terminal 100 and extends downwardly from the top end of the clamping elastic sheet 200 and the oval gear shape of the recess 101 and those dovetailed shape 102, the connection therebetween becomes more reliable.

The manufacturing method of the modular plug of the present embodiment, referring to FIG. 4, can specifically be, on the basis of the present technical solution, a first rear mould 60 provided on a lower mould board 20. On the lower mould board 20 is also provided paralleledly a second rear mould 50. The first rear mould 60 and the second rear mould 50 are the same in shape, size and mould cavity. The first front mould 40 is provided on the upper mould board 10. The upper mould board 10 is also provided paralleledly a second front mould 30. Referring to FIG. 4, the upper mould board 10 is provided as paralleledly fixed. The lower mould board 20 is provided in parallel and can rotate in motion at 180 degree.

The above is a description of the modular plug of the present application, for using to assist in understanding the present application. However, the embodiments contained in the present application are not limited to these ones, any changes, modifications, replacements, combinations and simplifications etc are all equivalent substituting methods, which shall all fall within the protection scope of the present application.

1. A modular plug, comprising a terminal containing a metal contact, wherein an upper surface of a front end of the terminal is provided with a recess, an upper side of the terminal is connected with a clamping elastic sheet through injection moulding, a front end of the clamping elastic sheet is provided with a projection that matches the recess in shape and size, the projection is tightly inlaid within the recess, a top end of the clamping elastic sheet extends downwardly and overlays on a front surface of the terminal, a material of the clamping elastic sheet is nylon or POM, and a material of the terminal is polycarbonate resin.

2. The modular plug according to claim 1, wherein the clamping elastic sheet comprises a connecting head fixed at the front end of the terminal and an elastic sheet extended in slanted upward direction from an end of the connecting head, the elastic sheet is provided with a clamping projection protruding from both sides and proximate to the end of the connecting head.

3. The modular plug according to claim 2, wherein the connecting head and the elastic sheet are formed from one single injection moulding.

4. The modular plug according to claim 1, wherein the modular plug is a RJ45, RJ50, RJ61, RJ48, RJ25, RJ14, RJ12 or RJ11 connector.

5. The modular plug according to claim 1, wherein the recess has an oval gear shape and teeth of the recess that proximate to two ends of a central part of the recess form expanded dovetailed shape.

6. The manufacturing method of a modular plug according to claim 1, comprising the following steps:
(1) firstly, injection molding the terminal of the material of polycarbonate resin, and then injection molding the terminal of the material of polycarbonate resin having a irregularly shaped recess using a mould cavity of a first rear mould and a convex mould of a first front mould; and
(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

7. The method according to claim 6, wherein the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.

8. The modular plug according to claim 2, wherein the recess has an oval gear shape and teeth of the recess that proximate to two ends of a central part of the recess form expanded dovetailed shape.

9. The modular plug according to claim 3, wherein the recess has an oval gear shape and teeth of the recess that proximate to two ends of a central part of the recess form expanded dovetailed shape.

10. The modular plug according to claim 4, wherein the recess has an oval gear shape and teeth of the recess that proximate to two ends of a central part of the recess form expanded dovetailed shape.

11. The manufacturing method of a modular plug according to claim 2, comprising the following steps:
(1) firstly, injection molding the terminal of the material of polycarbonate resin, and then injection molding the terminal of the material of polycarbonate resin having a irregularly shaped recess using a mould cavity of a first rear mould and a convex mould of a first front mould; and
(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

12. The manufacturing method of a modular plug according to claim 3, comprising the following steps:
(1) firstly, injection molding the terminal of the material of polycarbonate resin, and then injection molding the terminal of the material of polycarbonate resin having a irregularly shaped recess using a mould cavity of a first rear mould and a convex mould of a first front mould; and
(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

13. The manufacturing method of a modular plug according to claim 4, comprising the following steps:
(1) firstly, injection molding the terminal of the material of polycarbonate resin, and then injection molding the terminal of the material of polycarbonate resin having a irregularly shaped recess using a mould cavity of a first rear mould and a convex mould of a first front mould; and
(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

14. The manufacturing method of a modular plug according to claim 5, comprising the following steps:
(1) firstly, injection molding the terminal of the material of polycarbonate resin, and then injection molding the terminal of the material of polycarbonate resin having a irregularly shaped recess using a mould cavity of a first rear mould and a convex mould of a first front mould; and
(2) secondly, under the condition of ensuring a temperature of an injection molding machine, opening and spirally loosening the first rear mould, covering the first rear mould on a second front mould, injection moulding a clamping elastic sheet using a mould cavity of the second front mould, opening and spirally loosening the first rear mould, and taking out an end product.

15. The method according to claim 11, wherein the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.

16. The method according to claim 12, wherein the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.

17. The method according to claim 13, wherein the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.

18. The method according to claim 14, wherein the first rear mould is provided on a lower mould board, on the lower mould board is also paralleledly provided with a second rear mould, the first rear mould and the second rear mould are the same in shape, size and mould cavity, the first front mould is provided on an upper mould board, on the upper mould board is also paralleledly provided with the second front mould, the upper mould board is provided as paralleledly fixed, the lower mould board is provided in parallel and is rotatable in motion at 180 degrees.
